(19) United States
(12) Patent Application Publication
(10) Pub. No.: US 2014/0328962 A1
(43) Pub. Date: Nov. 6, 2014

(54) APPARATUS FOR FILLING A CONFECTIONARY ARTICLE

(71) Applicant: Intercontinental Great Brands LLC, East Hanover, NJ (US)

(72) Inventor: Gabriel Petre, Newton, NJ (US)

(73) Assignee: Intercontinental Great Brands LLC, East Hanover, NJ (US)

(21) Appl. No.: 14/346,106

(22) PCT Filed: Sep. 20, 2012
(86) PCT No.: PCT/US12/56217

§ 371 Date: Mar. 20, 2014

Related U.S. Application Data
(60) Provisional application No. 61/538,189, filed on Sep. 23, 2011.

(51) Int. Cl. A23G 3/20; A23G 4/02; B29C 47/04

(52) U.S. Cl. CPC A23G 3/2007; B29C 47/04; A23G 4/02; B29L 2009/005
USPC 425/132

(57) ABSTRACT

Disclosed is a nozzle assembly for usage with at least one conduit, the nozzle assembly including a nozzle support (88) including a nozzle entry surface, a nozzle exit surface, and a plurality of nozzle holding conduits defined by the nozzle support (88) and extending from the nozzle entry surface to the nozzle exit surface, the nozzle support being in removable association with the at least one conduit at the nozzle entry surface, and a plurality of nozzles (76) removably associated with the nozzle support (88) via insertion of the plurality of nozzles (76) into the plurality of nozzle holding conduits, the plurality of nozzles (76) being in fluid communication with the at least one conduit via the removable association between the nozzle support (88) and the at least one conduit.

### FIELD

The disclosure relates generally to an apparatus, system, and method for filling a confectionary article, and more specifically to an apparatus, system, and method for filling a confectionary article such that it includes one or more capillaries that may contain a fluid or other material.

### BACKGROUND

It is desirable to produce confectionery formed of different components, so as to increase sensory pleasure. A number of confectionery products exist, which have a flavored liquid or syrup center that is released upon chewing. For example, WO2007056685 discloses an apparatus and method for the continuous production of center-filled confectionery products in the format of a continuous extrudate having a plurality of center-filled confectionery.

However, it can be difficult to create confectionary pieces from confectionary output (such as rope), wherein the pieces include more than one capillary containing fluid or other material. This is particularly true of confectionary with capillaries spaced close together in linear and non-linear patterns and greater numbers, as the capillaries of such confectionary can be prone to collapse and deformity (particularly considering the pressures involved with some confectionary extrusions).

As multiple fluid/material filled capillaries can be beneficial to sensory pleasure, an apparatus, system, and method for efficiently filling a confectionary article such that the article includes capillaries in desirable numbers would be beneficial.

### SUMMARY

Disclosed is a nozzle assembly for usage with at least one conduit, the nozzle assembly including a nozzle support including a nozzle entry surface, a nozzle exit surface, and a plurality of nozzle holding conduits defined by the nozzle support and extending from the nozzle entry surface to the nozzle exit surface, the nozzle support being in removable association with the at least one conduit at the nozzle entry surface, and a plurality of nozzles removably associated with the nozzle support via insertion of the plurality of nozzles into the plurality of nozzle holding conduits, the plurality of nozzles being in fluid communication with the at least one conduit via the removable association between the nozzle support and the at least one conduit.

Also disclosed is a system for filling a confectionary article, the system including at least one conduit housed by a conduit housing, the at least one conduit extending from at least one conduit input to a at least one conduit output, a nozzle support including a nozzle entry surface, a nozzle exit surface, and a plurality of nozzle holding conduits defined by the nozzle support and extending from the nozzle entry surface to the nozzle exit surface, the nozzle support being in removable association with the at least one conduit at the nozzle entry surface, and a plurality of nozzles removably associated with the nozzle support via insertion of the plurality of nozzles into the plurality of nozzle holding conduits, the plurality of nozzles being in fluid communication with the at least one conduit via the removable association between the nozzle support and the at least one conduit.

### BRIEF DESCRIPTION OF THE FIGURES

The accompanying drawings incorporated in and forming a part of the specification embodies several aspects of the present invention and, together with the description, serve to explain the principles of the invention. In the drawings:

FIG. 1 is an exploded perspective view of an apparatus for filling a confectionary article according to an exemplary embodiment;

FIG. 1a is a perspective view of the apparatus shown in FIG. 1;

FIG. 2 is a perspective view of an element of the apparatus shown in FIG. 1;

FIG. 2a is an elevation view of the element shown in FIG. 2;

FIG. 3 is a top perspective view of an element of the apparatus shown in FIG. 1;

FIG. 3a is a bottom perspective view of the element shown in FIG. 3;

FIG. 3b is an elevation view of the element shown in FIG. 3;

FIG. 4 is a bottom perspective view of an element of the apparatus shown in FIG. 1;

FIG. 4a is a top perspective view of the element shown in FIG. 4;

FIG. 5 is a bottom perspective view of an element of the apparatus shown in FIG. 1;

FIG. 5a is a top perspective view of the element shown in FIG. 5;

FIG. 5b is a bottom plan view of the element shown in FIG. 5;

FIG. 6 is a perspective view of an element of the apparatus shown in FIG. 1;

FIG. 7 is a top perspective view of an element of the apparatus shown in FIG. 1;

FIG. 7a is a bottom perspective view of the element shown in FIG. 7;

FIG. 8 is a perspective view of an element of the apparatus shown in FIG. 1;

FIG. 9 is a bottom perspective view of an element of the apparatus according to another exemplary embodiment;

FIG. 9a is a top perspective view of the element shown in FIG. 9;

FIG. 10 is a bottom perspective view of an element of the apparatus configurable with the element shown in FIG. 9;

FIG. 10a is a top perspective view of the element shown in FIG. 10;

FIG. 11 is a perspective view of an element of the apparatus configurable with the element shown in FIG. 9;

FIG. 12 is a bottom perspective view of an element of the apparatus configurable with the element shown in FIG. 9;

FIG. 12a is a top perspective view of the element shown in FIG. 10;

FIG. 13 is a top perspective view of a portion of the apparatus including the elements shown in FIGS. 9-12;

FIG. 14 is a bottom perspective view of an element of the apparatus according to another exemplary embodiment;

FIG. 14a is a top perspective view of the element shown in FIG. 14;

FIG. 15 is a bottom perspective view of an element of the apparatus configurable with the element shown in FIG. 14;

FIG. 15a is a top perspective view of the element shown in FIG. 15;

FIG. 16 is a perspective view of an element of the apparatus configurable with the element shown in FIG. 14;

FIG. 17 is a bottom perspective view of an element of the apparatus according to another exemplary embodiment;

FIG. 17a is a top perspective view of the element shown in FIG. 17;

FIG. 18 is a bottom perspective view of an element of the apparatus configurable with the element shown in FIG. 17;

FIG. 18a is a top perspective view of the element shown in FIG. 18;

FIG. 19 is a perspective view of an element of the apparatus configurable with the element shown in FIG. 17;

FIG. 20 is a bottom perspective view of an element of the apparatus according to another exemplary embodiment;

FIG. 20a is a top perspective view of the element shown in FIG. 20;

FIG. 21 is a bottom perspective view of an element of the apparatus configurable with the element shown in FIG. 20;

FIG. 21a is a top perspective view of the element shown in FIG. 21;

FIG. 22 is a perspective view of an element of the apparatus configurable with the element shown in FIG. 20;

FIG. 23 is a bottom perspective view of an element of the apparatus according to another exemplary embodiment;

FIG. 23a is a top perspective view of the element shown in FIG. 23;

FIG. 24 is a bottom perspective view of an element of the apparatus configurable with the element shown in FIG. 23;

FIG. 24a is a top perspective view of the element shown in FIG. 24;

FIG. 25 is a perspective view of an element of the apparatus configurable with the element shown in FIG. 23;

FIG. 26 is a bottom perspective view of an element of the apparatus according to another exemplary embodiment;

FIG. 26a is a top perspective view of the element shown in FIG. 26;

FIG. 27 is a bottom perspective view of an element of the apparatus configurable with the element shown in FIG. 26;

FIG. 27a is a top perspective view of the element shown in FIG. 27;

FIG. 28 is a perspective view of an element of the apparatus configurable with the element shown in FIG. 26;

FIG. 29 is a perspective view of a portion of the apparatus including a portion of the elements shown in FIGS. 26-28;

FIG. 30 is another perspective view of a portion of the apparatus including a portion of the elements shown in FIGS. 26-28;

FIG. 31 is a perspective view of a system for filling a confectionary article according to an exemplary embodiment, the system including the apparatus of FIG. 1;

FIG. 32 is an elevation view of the system shown in FIG. 31;

FIG. 33 is a cross-sectional plan view of the system shown in FIG. 31;

FIG. 34 is an enlarged partial cross-sectional plan view of the system as shown in FIG. 33 in the area of B;

FIG. 35 is a perspective view of an element of the system shown in FIG. 31;

FIG. 36 is a perspective view of an element of the system shown in FIG. 31;

FIG. 37 is a perspective view of an element of the system shown in FIG. 31;

FIG. 37a is a perspective view of an element of the system shown in FIG. 31;

FIG. 38 is a perspective view of another embodiment of an apparatus for filling a confectionary article according to an exemplary embodiment;

FIG. 39 is a cross-sectional elevation view of a product formed by the system of FIG. 31; and

FIG. 40 is a cross-sectional elevation view of a product formed by a system incorporating the apparatus of FIG. 38.

### DETAILED DESCRIPTION

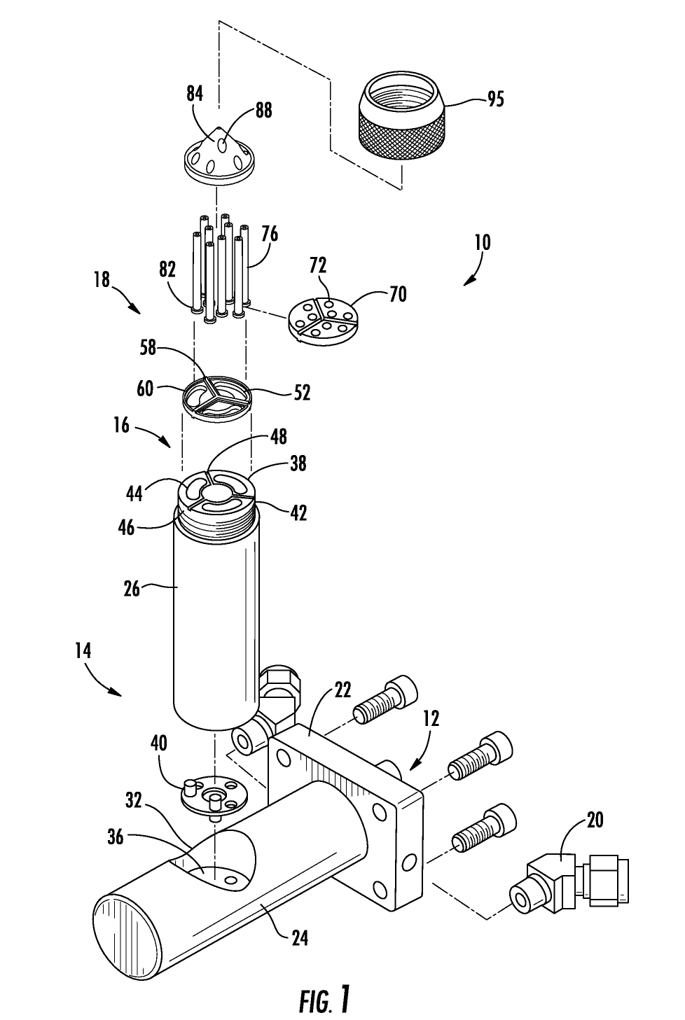

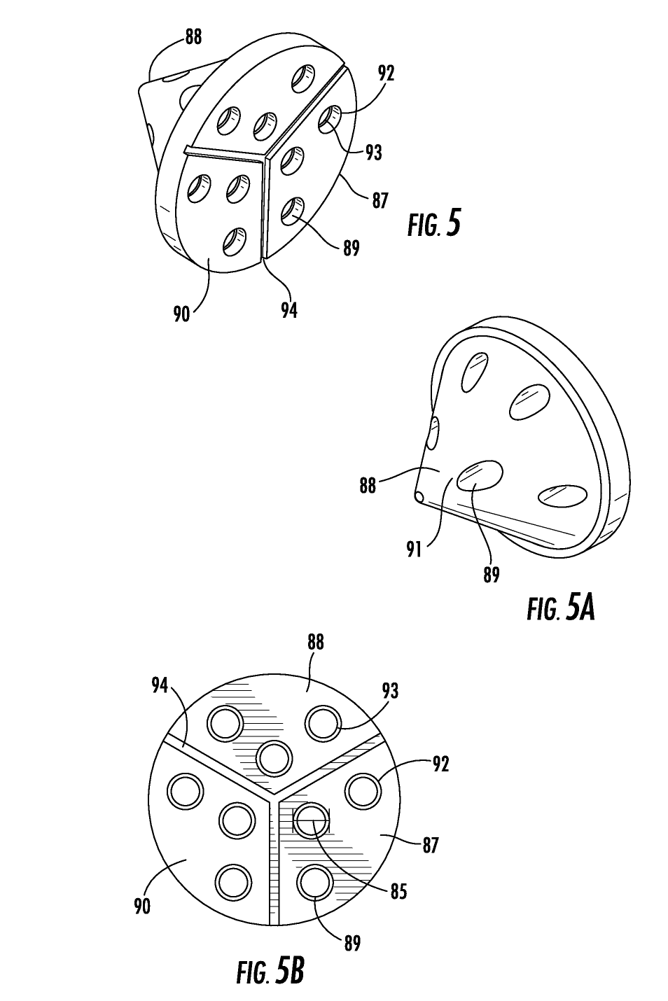

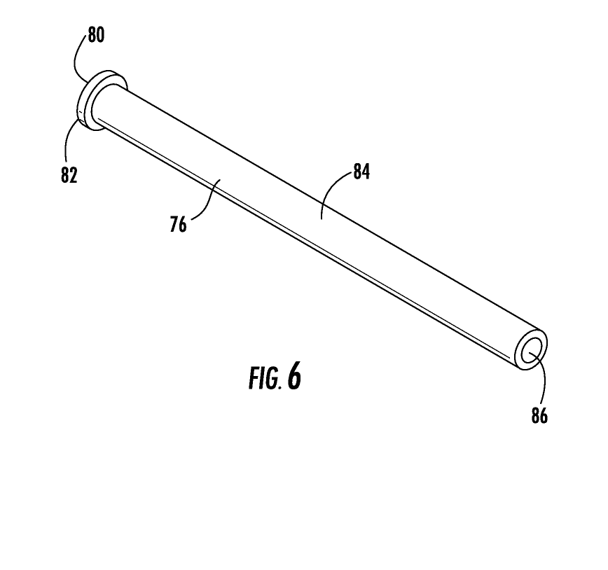

Referring first to FIGS. 1-8, an exemplary embodiment of an apparatus 10 for filling a confectionary article is illustrated. The apparatus 10 includes input section 12, a conduit section 14, an output section 16, and a nozzle/nozzle support section 18. The apparatus 10 is configured to fill a confectionary body with a fluid (i.e. molten candy, gum, gel, air, etc.). As will be discussed in greater detail below, the sections of the apparatus 10 transport the fluid from a fluid supply (not illustrated) associated with the input section 12 to an output from the nozzle/nozzle support section 18.

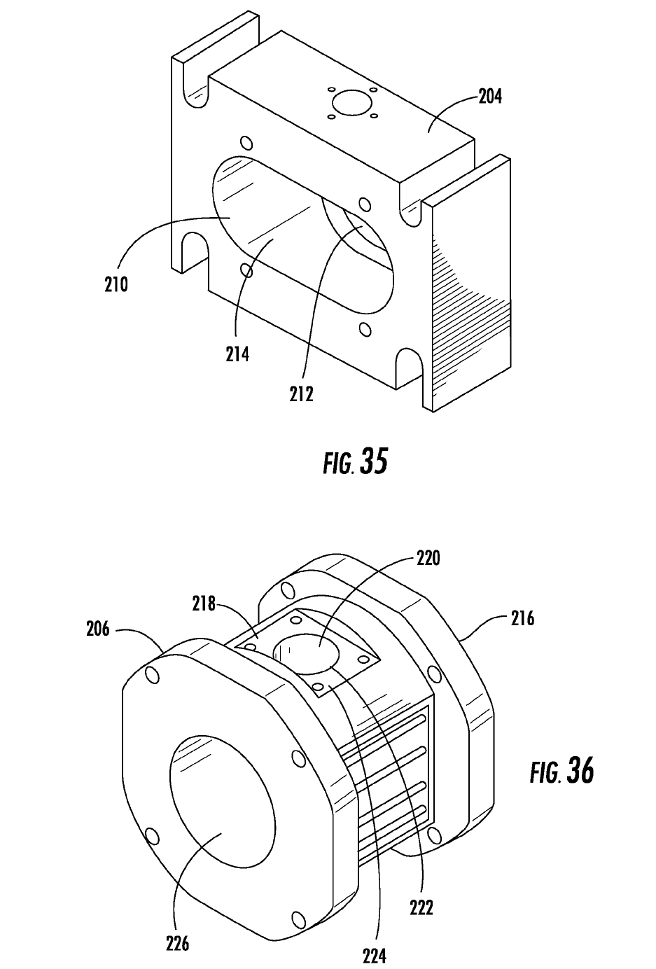

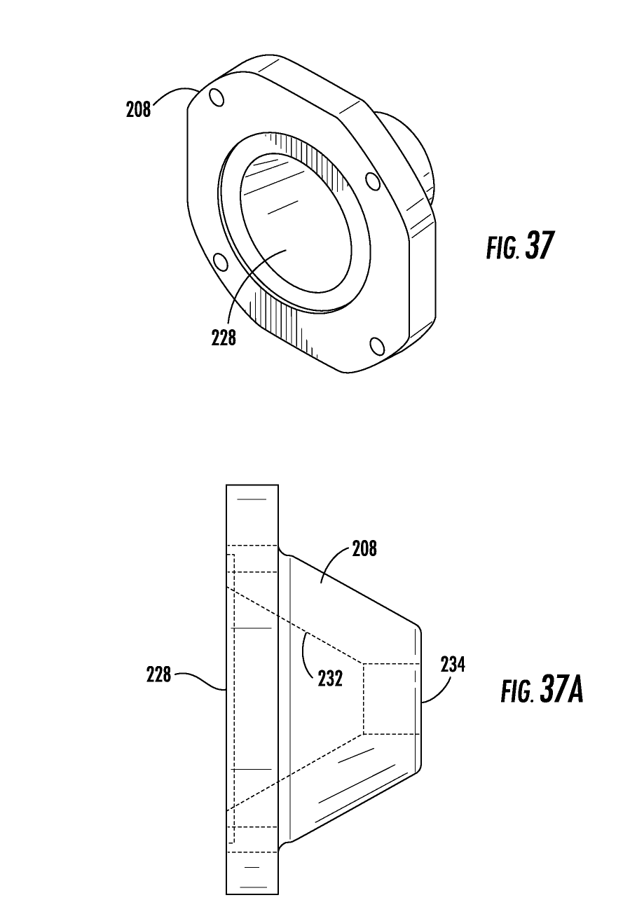

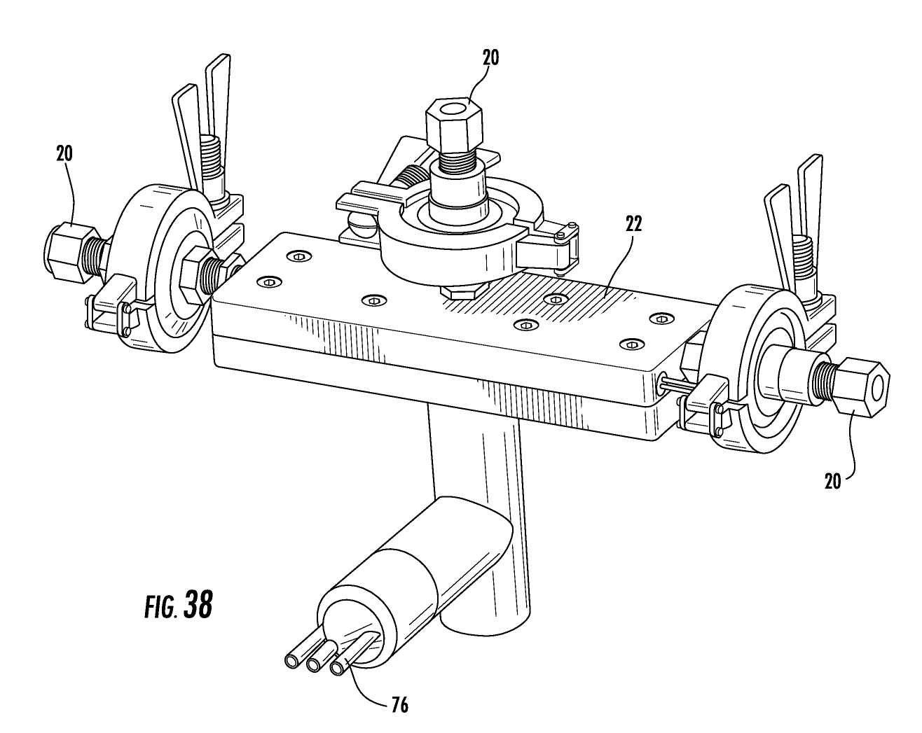

As shown in FIGS. 1 and la, an exemplary embodiment of the apparatus 10 includes three input ports 20 (such as but not limited to valves) and an input block 22. The input ports 20 may be associated with a single fluid supply including one type of fluid, or three separate fluid supplies that may each include the same fluid or different fluids. Via this association, the ports 20 allow entry of fluid into the apparatus 10 for transport to the conduit section 14, wherein each valve 20 may be individually opened or closed to allow one to three types of fluid (or no fluid) to enter the apparatus 10. Of course, while the exemplary embodiment of FIGS. 1 and la include three such ports or valves 20, any desirable number of ports or valves may be used. In the alternate embodiment shown in FIG. 38, the ports 20 are also shown to enter the block 22 at different angels (such as but not limited to the orthogonal configuration shown in FIG. 38). The input block 22 serves to support these ports 20, as well as associate the conduit section 14 (and apparatus 10 as a whole) with a larger extruder system that will be discussed in greater detail with reference to FIGS. 31-37a, later in the disclosure.

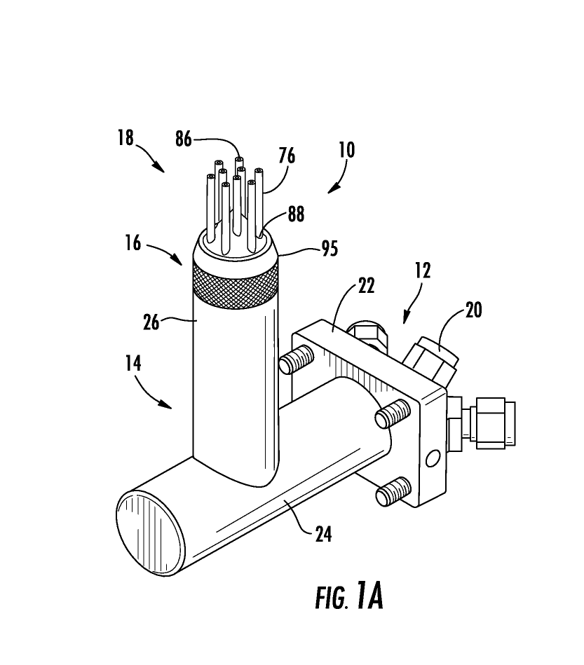

Referring to FIGS. 1-1a, 2-2a, and 3-3b in particular, the conduit section 14 includes and entry portion 24 and a turn portion 26, the turn portion 26 being disposed substantially orthogonal to the entry portion 24. The entry portion 24 is fixed (via unitary construction, threaded instrument, welding, etc.) to the block 22, and defines entry conduits 28 that are in fluid communication with the ports 20. These conduits 28 are included in the same number as the ports 20, and extend from a port surface 30 of the block 22 to a turn recess 32, which extends in an axial direction into the entry portion 24. As is best shown in FIG. 2a, the conduits 28 include turns 34, that allow the conduits 28 to extend from the port surface 30 to a turn recess surface 36 disposed orthogonal thereto. In the exemplary embodiment of FIG. 2a these turns 34 are made at 90 degree angles, though the apparatus 10 may also include ranges such as but not limited to 90 degrees +/−1 to 5 degrees, 80 to 90 degrees, 90 to 100 degrees, 75 to 95 degrees, 85 to 105 degrees, 70 to 100 degrees, 80 to 110 degrees, and 70 to 110 degrees.

The turns 34 further allows fluid communication between the conduits 28, and turn portion conduits 38 defined by the turn portion 26, which nests in the turn recess 32 and may be affixed to the recess surface 36 (via threaded instrument 40 in this exemplary embodiment). These conduits 38 may include greater dimensions (such as width) than the entry conduits 28, so as to potentially alleviate pressure at the flow from the entry conduits 28 to the turn conduits 38. In an exemplary embodiment, these turn conduits 38 include a “kidney bean” shape.

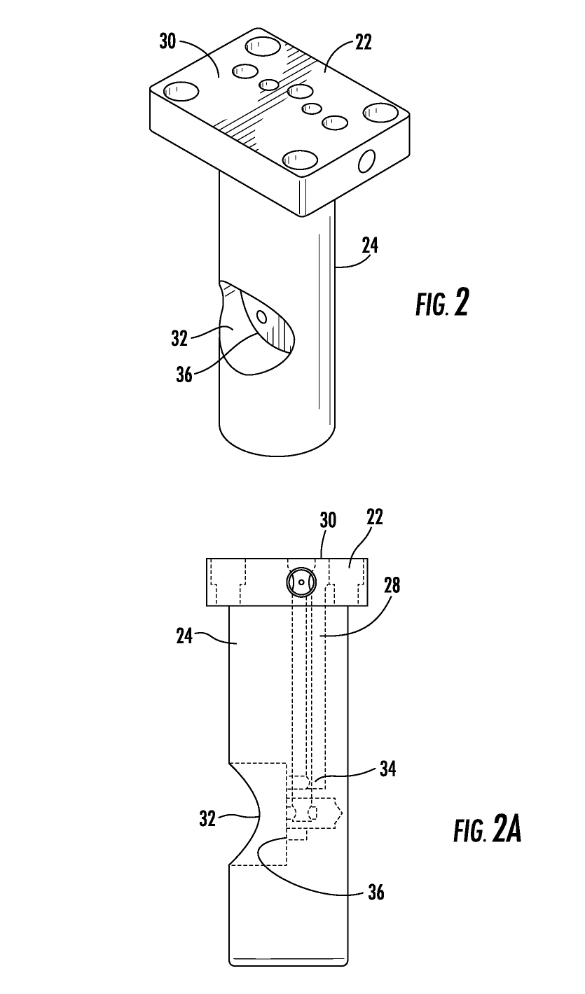

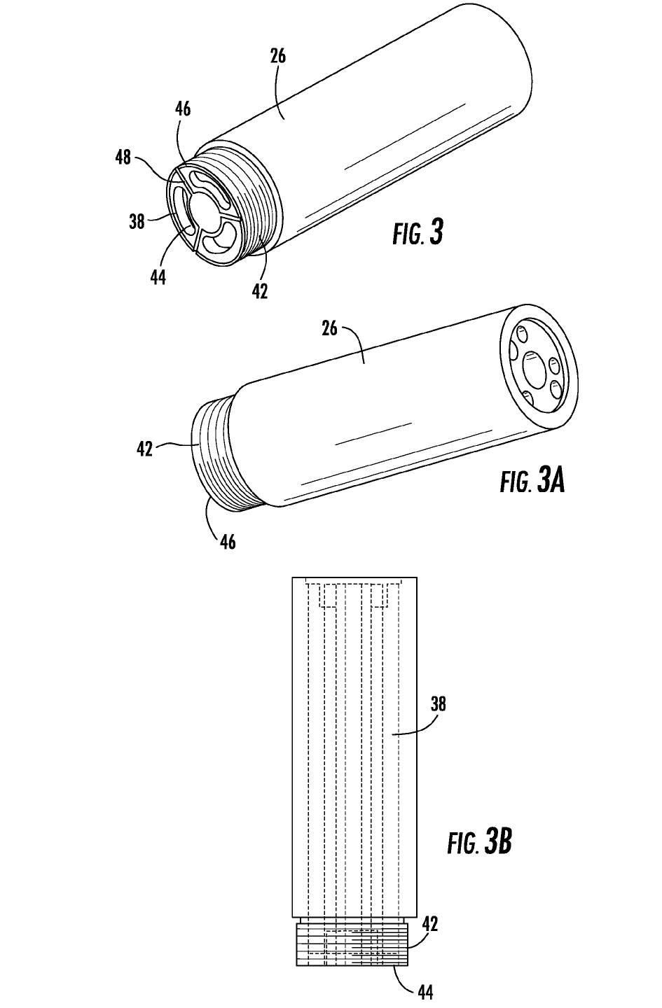

As shown in FIGS. 1 and 3b in particular, the turn portion conduits 38 (which are included in the same number as the entry conduits 28 and ports 20) extend from communication with the recess surface 36 to the output section 16, which begins with a threaded extension 42 extending from the turn portion 26. The turn portion conduits 38 extend through the threaded extension 42, and terminate at output openings 44. In addition to extending the turn conduits 38, the threaded extension includes a threaded outer surface 46 and association grooves 48.

With reference to FIGS. 1, 7, and 7a, the association grooves 48 are sized and positioned to nest and align with lower ridges 50 of reservoir connector 52, so as to align the threaded extension 42 with the reservoir connector 52 in a manner that will allow for fluid communication and prevent relative rotation between the two elements. The connector 52 includes a lower surface 54, an upper surface 56, a separator wall 58, a parametric wall 60, and reservoir openings 62 included in the same number as the output openings 44. In the exemplary embodiment shown in the Figures, the reservoir openings 62 are defined by the separator wall 58 and parametric wall 60, and include a geometry that is substantially similar to (or slightly larger than) the output openings 44. These reservoir openings 62 further extend from the lower surface 54 to the upper surface 56, thereby communicating the output openings 48 with reservoir cavities 64. In the exemplary embodiment shown in the Figures, the separator wall 58 defines three cavities 64, which is one for each of the port 20, conduits 28, 38, and output openings 48.

Referring now to FIGS. 1, 4, 4a, and 7, the separator wall 58 further includes an upper ridge 66 sized and positioned to nest and align with grooves 67 disposed in a lower surface 68 of nozzle base 70, so as to align the reservoir connector 52 with the nozzle base 70 in a manner that will allow for fluid communication and prevent relative rotation between the two elements. The grooves 67, along with upper ridges 69 delimit three sections 71 that are similar in dimension to the reservoir cavities 64. This nozzle base 70 includes a plurality of fluid openings 72 that extend from the lower surface 68 to an upper surface 74. At an upper surface, nozzles 76 of the nozzle/nozzle support section 18 are aligned with the fluid openings 72 in the same number as the fluid openings 72. However, unlike the numbers discussed previously, the number of fluid openings 72 (and nozzles 76 aligned therewith) is greater than the number of port 20, conduits 28, 38, and output openings 48.

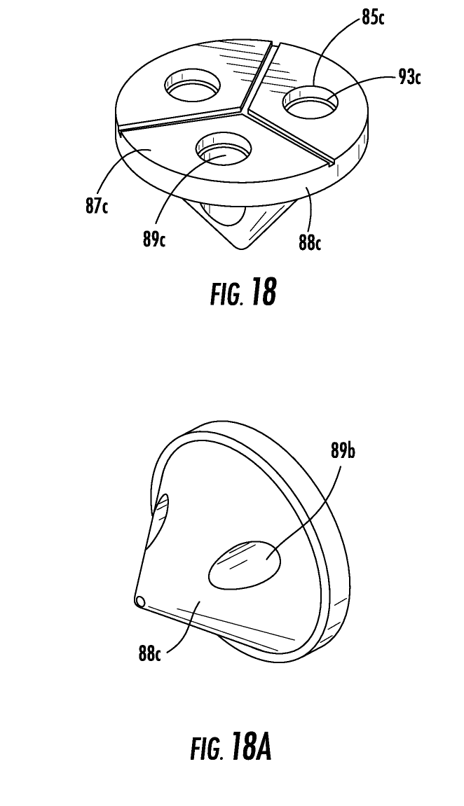

This greater number of fluid openings/nozzles makes the reservoir cavities 64 significant for a few reasons. First, the greater size of the reservoir cavities 64 relative to the output openings 48 (as measured in at least cross-sectional area planar to the upper and lower surface 54, 56) allows the openings 48 to communicate with fluid openings 72 numbered and spaced beyond perimeters of the output openings 48. For example, if fifteen capillaries are desired in a confectionary a nozzle base 70 with fifteen fluid openings 72 (and fifteen aligned nozzles 76), such as that shown in FIG. 18, the geometry of the output openings 48 would be unable to communicate with each opening 72 due to insufficient size. The reservoir cavities alleviate this issue, and allow/adapt the output openings 48 for communication with interchangeable nozzle bases 70 inclusive of varying numbers of openings 72 and nozzles 76.

Second, the greater size of the reservoir cavities 64 relative to the output openings 48 allows fluid flow to be effectively funneled from the output openings 48 to the much smaller fluid openings 72. These cavities 64 thereby act to alleviate pressure at the smaller fluid openings.

Referring to the nozzle/nozzle support section 18 of FIGS. 1, 1a, 5-5b, 6, and 8, a means of associating the nozzles 76 with the output section 16 and conduit section 14 will now be discussed. In the exemplary embodiments shown in Figures la and 6, the nozzles 76 are each shown to include a nozzle input 80, nozzle flange 82, nozzle body 84, and nozzle output 86. Each nozzle flange 82 includes a diameter that is larger than the openings 72 of the nozzle base 70. This allows each nozzle 76 to abut the upper surface of the nozzle base 70, which further and effectively allows the nozzle base 70 to function as a base.

A nozzle support 88 (including a shape such as but not limited to a cone) that is removably associable with the nozzles 76 may then slide over the nozzles 76 via support openings 89. These support openings 89 extend from a lower surface 90 of the support 88 to an upper surface 91 of the support, and each include a recess portion 92 at the lower surface 89. The recess portions 92 are sized to nest with the nozzle flanges 82 via inclusion of a greater, major diameter 85 at the recess 92 than a remainder of the openings 89, and a depth that is substantially equal to a height of the flanges 82. The remainder of each opening is sized such that the nozzle body 84, but not the nozzle flange 82, may pass therethrough. Via this configuration, the flange 82 is effectively sandwiched between the upper surface 74 of the nozzle base 70 and a minor diameter surface 93 (ceiling of the recess 92) of the openings 89. In addition, the lower surface 90 of the support 88 includes grooves 94 sized and positioned to nest and align with ridges 69 extending from the upper surface 74 of the nozzle base, so as to align the support 88 and nozzles 76 with the nozzle base 70 and fluid openings 72 in a manner that will allow for fluid communication and prevent relative rotation between the two elements. The grooves 94 delimit three sections 87 that are similar in dimension to the reservoir cavities 64 and sections 71.

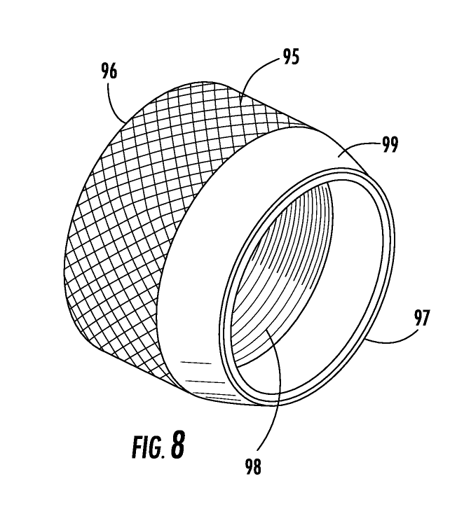

With the support 88 and nozzles 76 aligned with and positioned upon the nozzle base 70 and fluid openings 72 respectively, the support 88 may be affixed to the output section 16 via a threaded ring 95. The treaded ring (as shown in FIGS. 1, 1a, 8 and 8a) includes a major diameter 96, a minor diameter 97, a threaded inner surface 98 at the major diameter 96, and a tapered portion 99 between the major diameter 96 and minor diameter 97. The threaded inner surface 98 is configured to threadingly engage the ring 95 to the threaded extension 42 via the threaded outer surface 46 thereof. The threaded surface slides over the nozzles 79 and support 88, and is screwed down upon the threaded extension 42 until the tapered portion 99 abuts the upper surface 91 of the nozzle support 88. In this manner, the ring 95 removably associates the nozzle support 88 and nozzles 76 (the flanges 82 of which being sandwiched in the recess 92 between the support 88 and the base 70) with output portion 16 and conduit portion 14, thereby assembling the apparatus 10 as shown in FIG. 1a.

The nozzle support 88, as affixed to the apparatus 10 via the ring 95, maintains the nozzles 76 at appropriate distances from each other during usage. The removable association between the nozzles 76, support 88, ring 95, base 70, and reservoir connector 52 with each other and a remainder of the apparatus 10 allows for interchangeability of the nozzles 76. This interchangeability further allows the apparatus 10 to be used with different numbers/types of nozzles, which may create different numbers, patterns and types of fluid filled capillaries in the confectionary bodies produced using the apparatus 10. The removable associations between each element also allows for more convenient and efficient cleaning and maintaining of the individual elements.

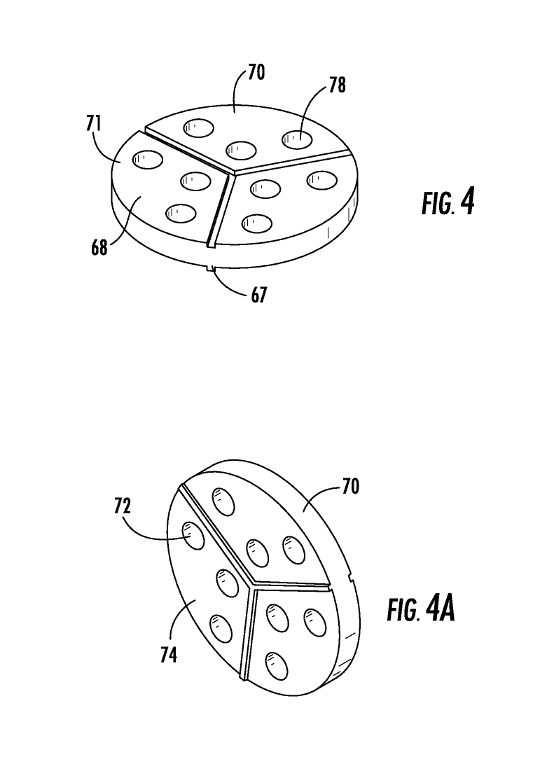

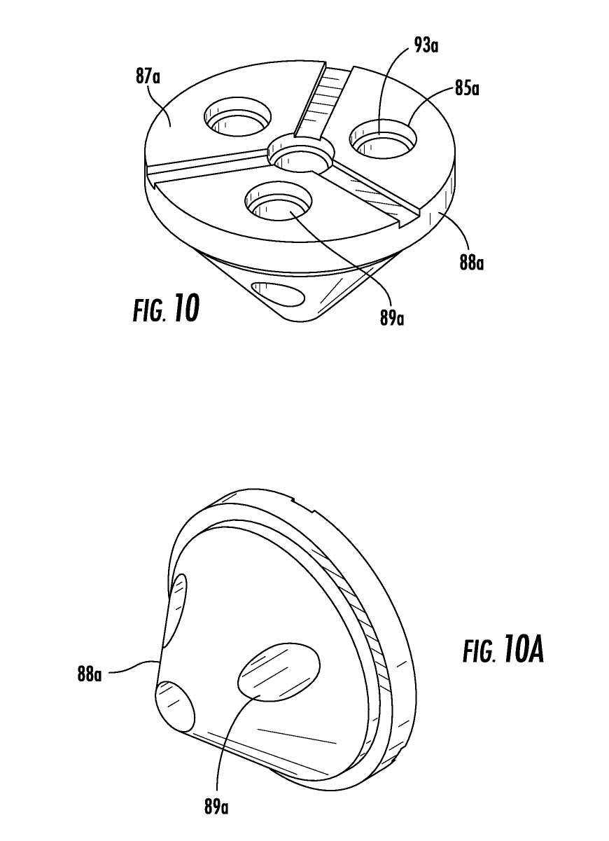

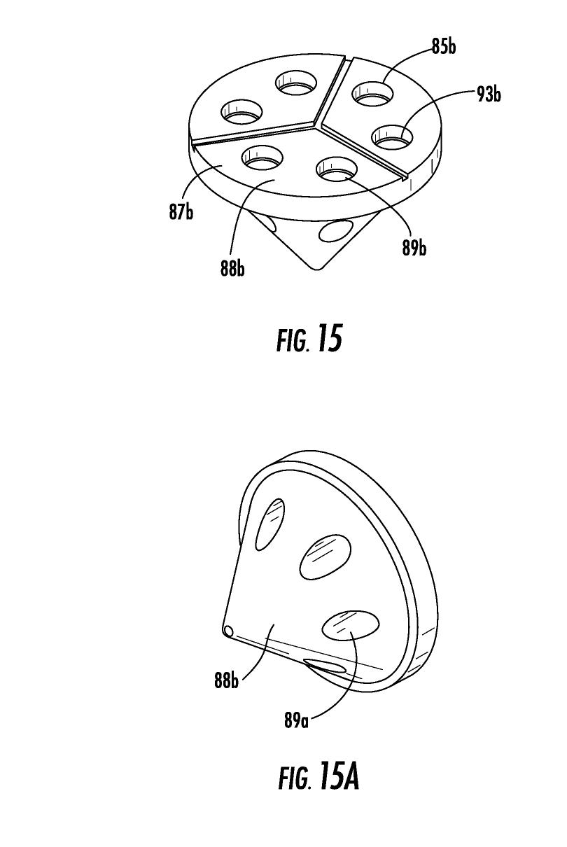

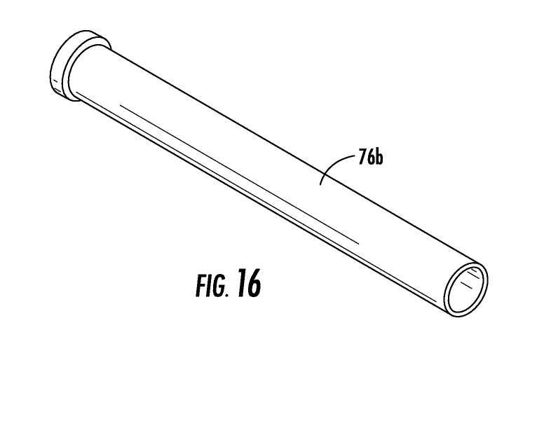

The term removable association is to be defined, throughout this disclosure, as an association that allows elements to be associated and disassociated without breaking or causing permanent damage to these elements. For example, elements that are threaded together, mated via groove and ridge, and/or connected via frictional fitting are to be considered removably associated. Elements that are of unitary construction or attached in a manner that would cause damage to the elements upon disassociation should not be considered removably associated. As mentioned above, removable association is beneficial to the apparatus 10 in that it allows for usage of various, interchangeable nozzle arrangements or assemblies. Some exemplary embodiments of such assemblies are shown in FIGS. 4-6 and 9-20, and discussed with reference to approximate dimensions hereinbelow.

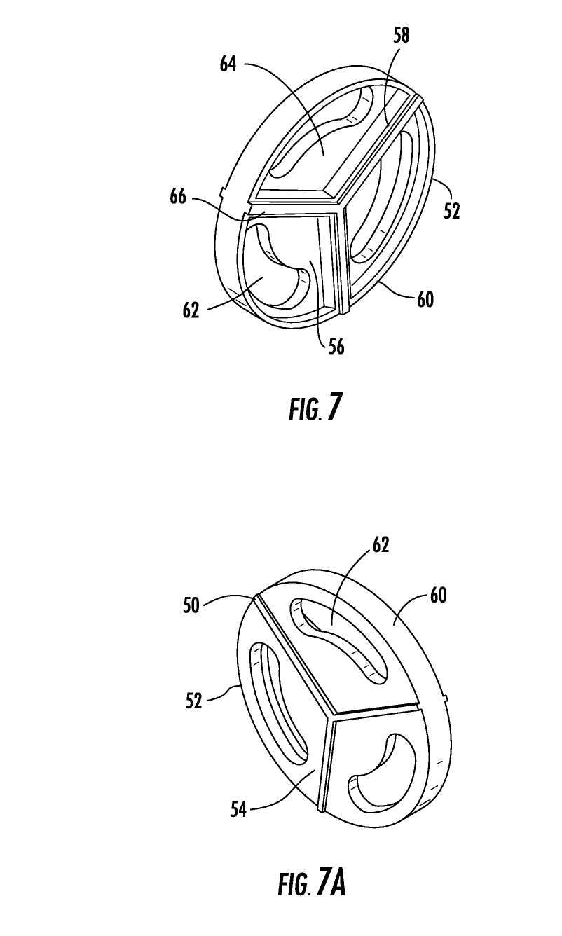

FIGS. 4-6 illustrate a nozzle base 70 and nozzle support 88 configured for use with nine nozzles such as nozzle 76. Each section 71 of the base 70 includes three fluid openings 72 of a 0.274 cm diameter. The support 88 similarly includes three sections 87 with three support openings 89 including major diameters 85 of 0.318 and minor diameters 93 of 0.254 cm. The nozzles 76 (such as the nozzle 76 shown in FIG. 6) include a length of 3.213 cm a diameter of 0.224 cm, a conduit diameter (actual diameter of fluid opening through the nozzle 76) of 0.147 cm, and a flange diameter of 0.318 cm.

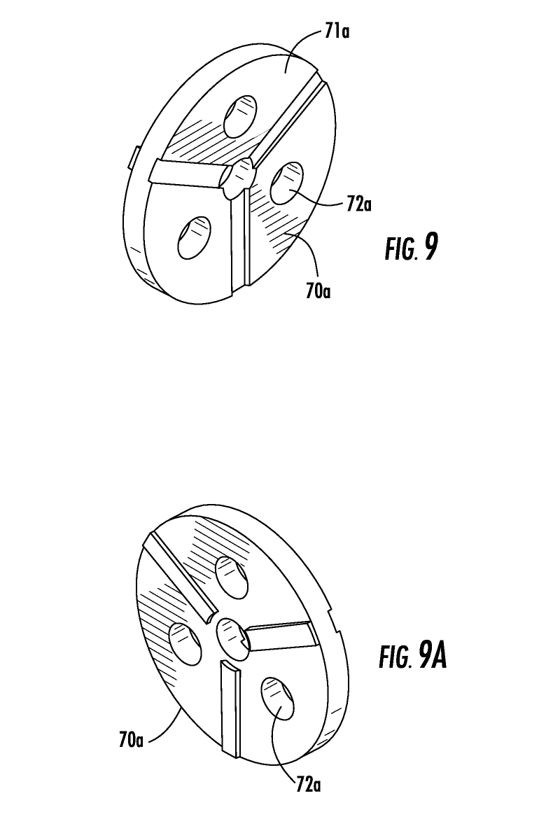

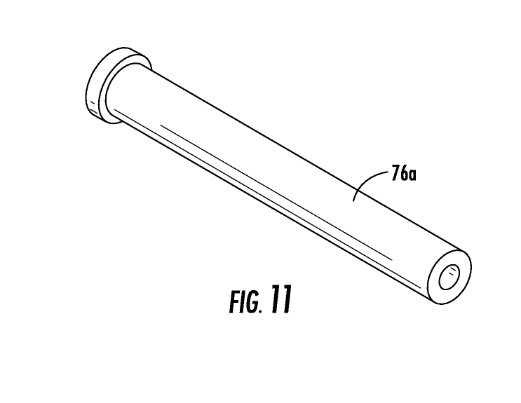

FIGS. 9-13 illustrate a nozzle base 70a and nozzle support 88a configured for use with four nozzles such as nozzle 76a. Each of the three sections 71a of the base 70a includes one fluid opening 72a of a 0.399 cm diameter. In addition, a fourth center opening 72a of a 0.399 cm diameter is positioned at a relative center of the base 70a. The support 88a similarly includes three sections 87a with one support opening 89a including a major diameter 85a of 0.508 cm and a minor diameter 93a of 0.401 cm, as well as a fourth center support opening 89a including a major diameter 85a of 0.508 cm and a minor diameter 93a of 0.401 cm. This fourth central support opening 89a aligns with the fourth center opening 72a of the base 70a. The nozzles 76a (such as the nozzle 76a shown in FIG. 11) include a length of 3.213 cm a diameter of 0.399 cm, a conduit diameter (actual diameter of fluid opening through the nozzle 76a) of 0.198 cm, and a flange diameter of 0.508 cm.

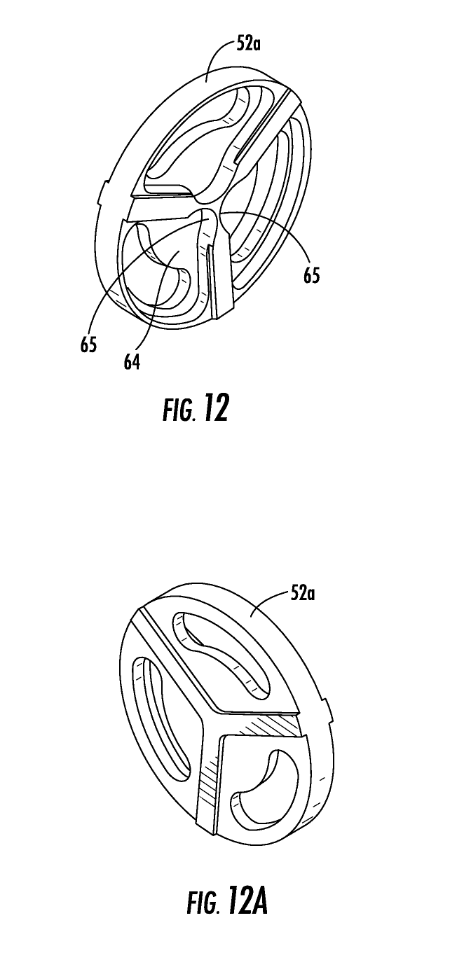

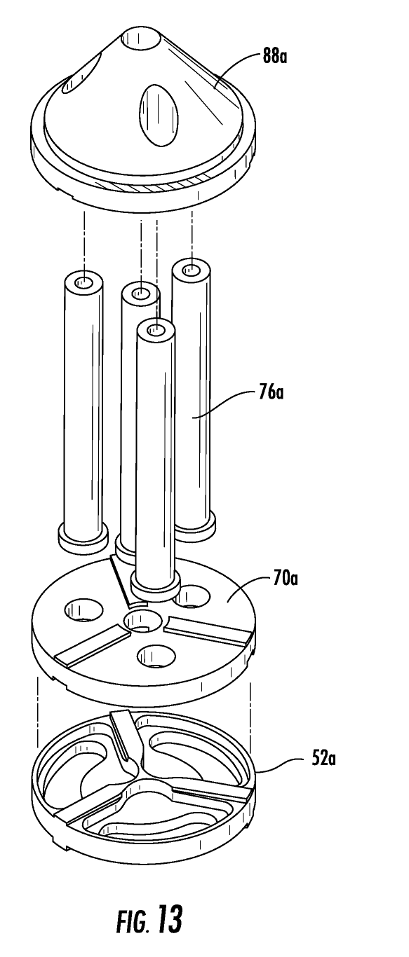

Referring now to FIGS. 12-13 in particular, a reservoir connector 52a that is similar to the previously discussed reservoir connector 52 is illustrated. This reservoir connector 52a only differs from the reservoir connector 52 via inclusion of cavity notches 65, which extend the three cavities 64 towards a relative center of the reservoir connector 52a. By including these notches 65, the reservoir connector 52a has an added function (added relative to reservoir 52) of allowing the openings 48 to communicate with center fluid openings 72, center support openings 89, and nozzle 76 associated therewith, such as those which are shown in FIGS. 9-11 and 13. The reservoir connector 52a functions in a manner similar (i.e. same advantages, etc.) to reservoir connector 52 in every or substantially every other way.

In addition, and as is best shown in FIG. 13, beyond inclusion of the central openings and nozzle the reservoir 52a, base 70a, support 88a, and nozzles 76a function and associate in a manner similar to reservoir connector 52, base 70, support 88, and nozzle 76 in every or substantially every way, and this would be the case for any center opening/nozzle configuration. It should also be appreciated that the center opening 72a, center support opening 88a, and corresponding center nozzle 76a, may be applied to any of the above or below embodiments, and include any desirable dimensions.

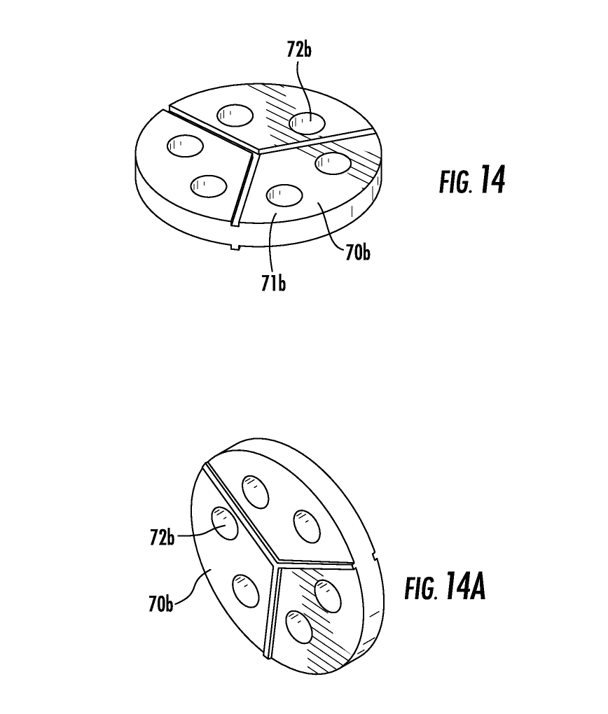

FIGS. 14-16 illustrate a nozzle base 70b and nozzle support 88b configured for use with six nozzles such as nozzle 76b. Each section 71b of the base 70b includes two fluid openings 72b of a 0.330 cm diameter. The support 88b similarly includes three sections 87b with two support 89b openings including major diameters 85b of 0.381 cm and minor diameters 93b of 0.318 cm. The nozzles 76b (such as the nozzle 76b shown in FIG. 11) include a length of 3.213 cm a diameter of 0.316 cm, a conduit diameter (actual diameter of fluid opening through the nozzle 76b) of 0.254 cm, and a flange diameter of 381 cm.

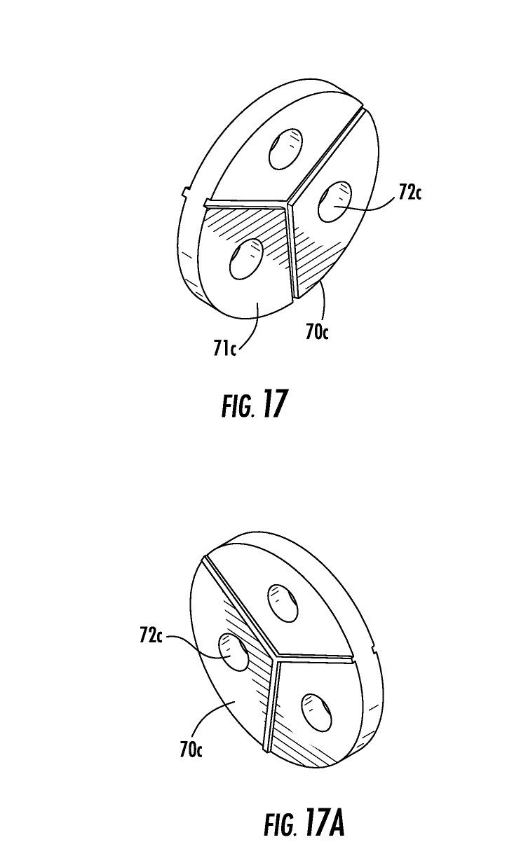

FIGS. 17-19 illustrate a nozzle base 70c and nozzle support 88c configured for use with three nozzles such as nozzle 76c. Each section 71c of the base 70c includes one fluid opening 72c of a 0.401 cm diameter. The support 88c similarly includes three sections 87c with one support opening 89c including major diameters 85c of 0.508 cm and minor diameters 93c of 0.401 cm. The nozzles 76c (such as the nozzle 76c shown in FIG. 14) include a length of 3.213 cm a diameter of 0.399 cm, a conduit diameter (actual diameter of fluid opening through the nozzle 76c) of 0.198 cm, and a flange diameter of 0.508.

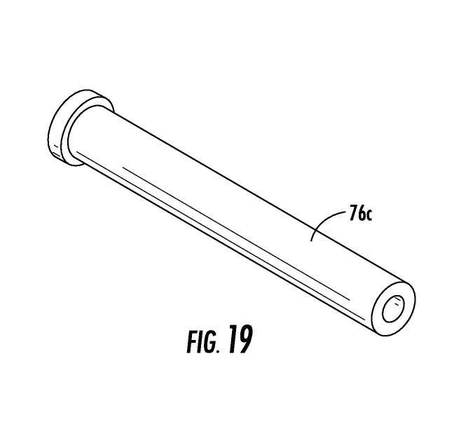

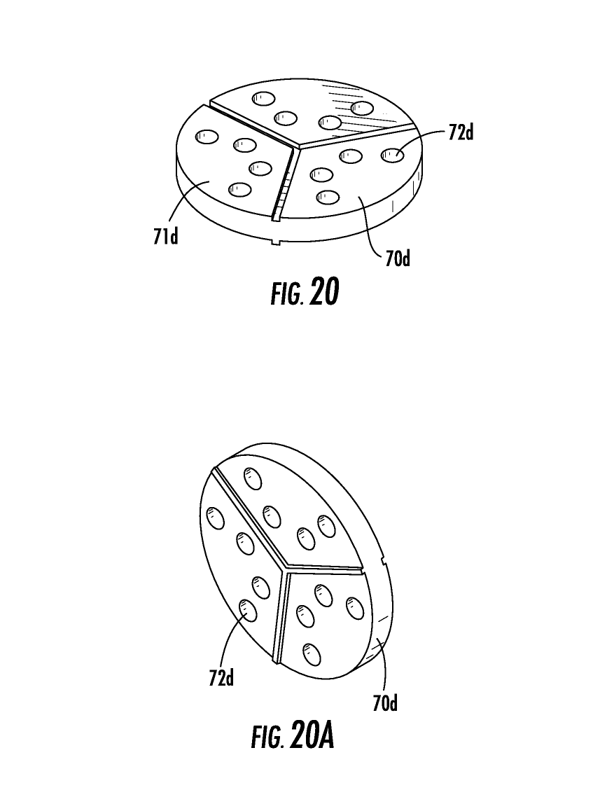

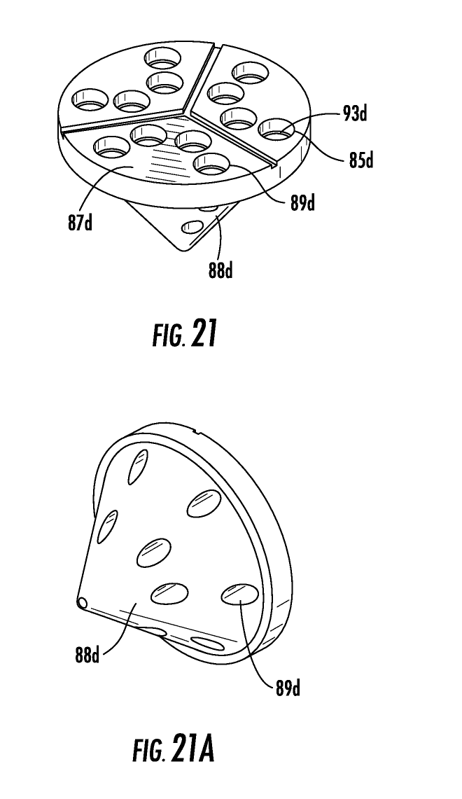

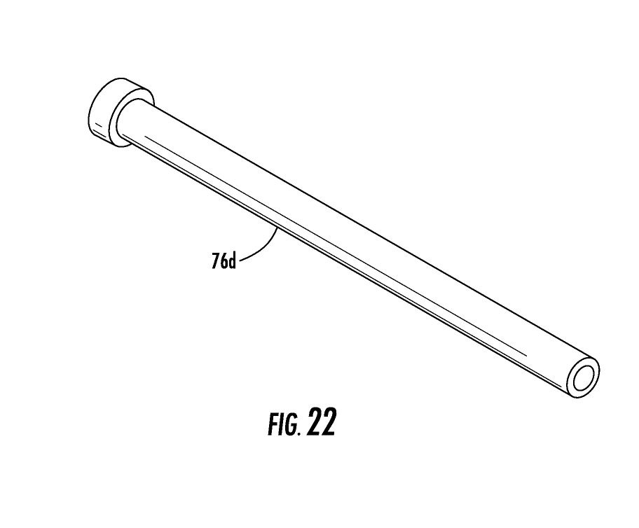

FIGS. 20-22 illustrate a nozzle base 70d and nozzle support 88d configured for use with twelve nozzles such as nozzle 76d. Each section 71d of the base 70d includes four fluid openings 72d of a 0.221 cm diameter. The support 88d similarly includes three sections 87d with four support openings 89d including major diameters 85d of 0.316 cm and minor diameters 93d of 0.203 cm. The nozzles 76d (such as the nozzle 76d shown in FIG. 17) include a length of 3.213 cm a diameter of 0.203 cm, a conduit diameter (actual diameter of fluid opening through the nozzle 76d) of 0.145 cm, and a flange diameter of 0.318 cm.

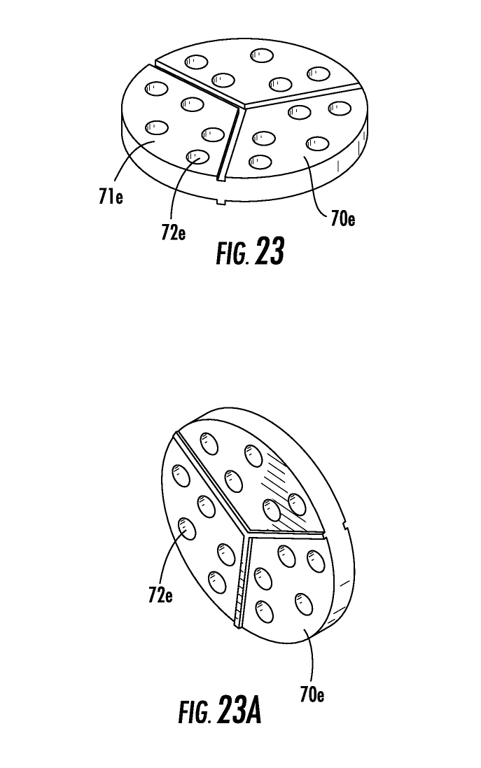

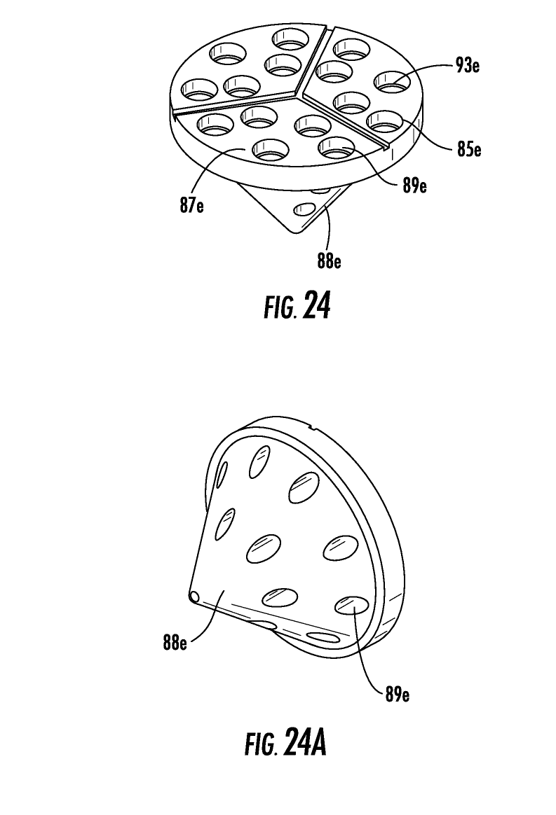

FIGS. 23-25 illustrate a nozzle base 70e and nozzle support 88e configured for use with fifteen nozzles such as nozzle 76e. Each section 71e of the base 70e includes five fluid openings 72e of a 0.224 cm diameter. The support 88e similarly includes three sections 87e with five support openings 89e including major diameters 85e of 0.318 cm and minor diameters 93e of 0.198 cm. The nozzles 76e (such as the nozzle 76e shown in FIG. 20) include a length of 3.213 cm a diameter of 0.198 cm, a conduit diameter (actual diameter of fluid opening through the nozzle 76e) of 0.147 cm, and a flange diameter of 0.318 cm.

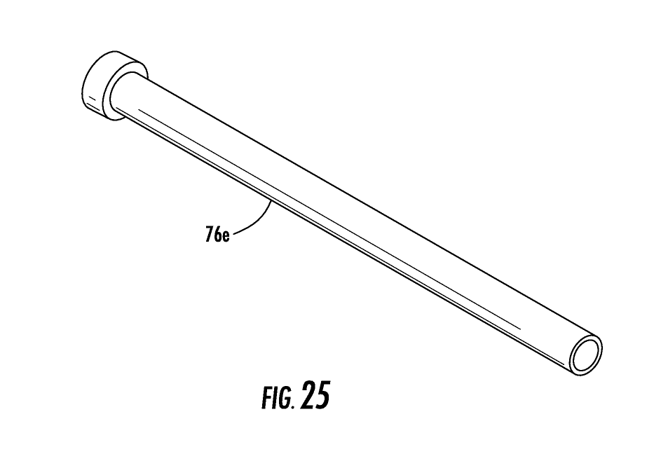

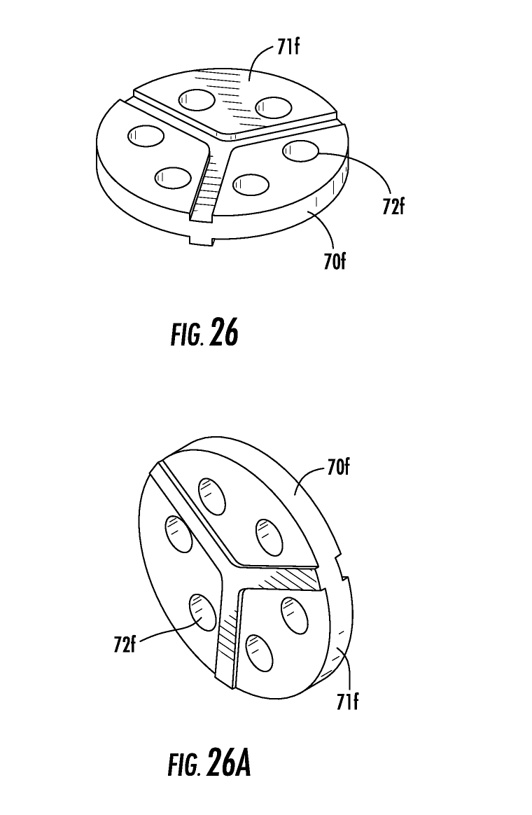

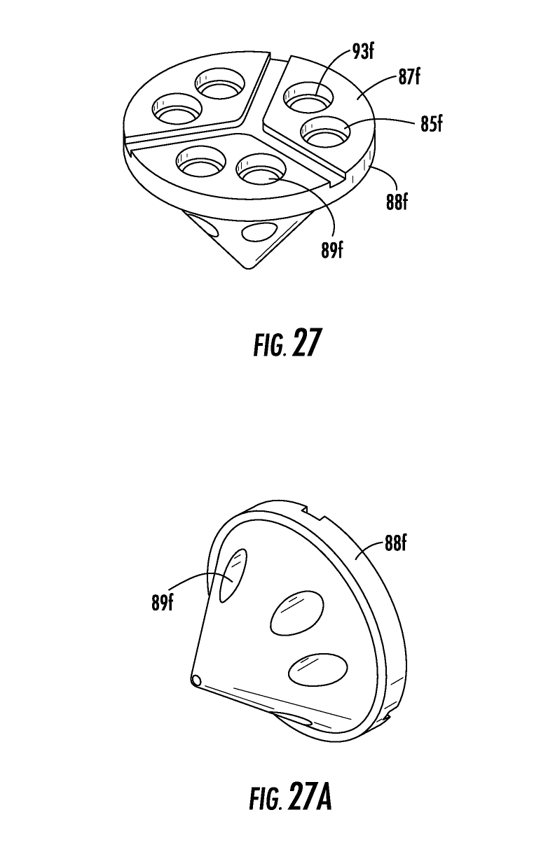

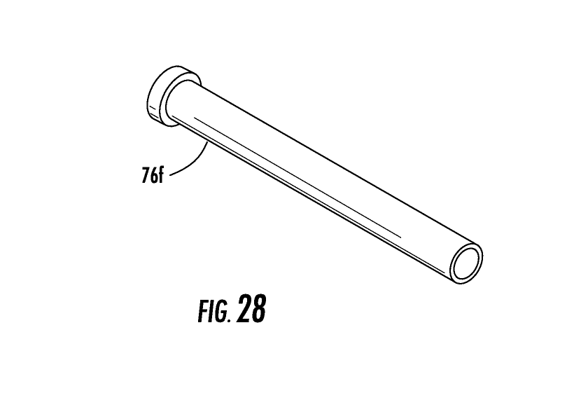

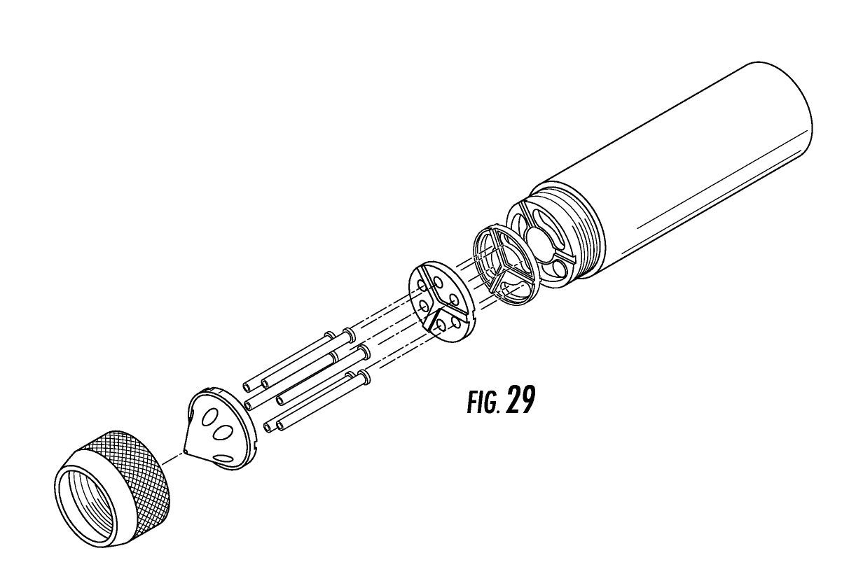

FIGS. 26-30 illustrate a nozzle base 70f and nozzle support 88f configured for use with six nozzles such as nozzle 76f. Each section 71f of the base 70f includes two fluid openings 72f of a 0.330 cm diameter. The support 88f similarly includes three sections 87f with five support openings 89f including major diameters 85f of 0.457 cm and minor diameters 93f of 0.325 cm. The nozzles 76f (such as the nozzle 76e shown in FIG. 20) include a length of 3.213 cm a diameter of 0.325 cm, a conduit diameter (actual diameter of fluid opening through the nozzle 76f) of 0.254 cm, and a flange diameter of 0.445 cm. FIGS. 29 and 30 show an exemplary embodiment of the apparatus 10 inclusive of the base 70f, support 88f, and nozzles 76f from the turn portion 26 of the conduit section 14 to the nozzle/nozzle support section 18.

It should be noted that the above discussed and illustrated examples are merely exemplary. The base 72 and support 88 may be configured with any desirable number of openings 72/89 of any desirable diameter, so as to accommodate any desirable number of nozzles 76 of any desirable diameter. The elements of the apparatus, particularly base openings 71 and support openings 89, may also be configured to position the nozzles in any configuration about the support 88. For example, each nozzle 76 may be positioned in linear alignment across a diameter/width (or portion thereof) of the support 88, as shown in FIG. 38.

Referring now to FIGS. 31-37a, a system 200 inclusive of the apparatus 10 is illustrated. The system 200, which acts as a head portion of an extruder, includes an outer conduit 202 defined by input portion 204, intermediate portion 206, and output portion 208.

Confectionary, such as gum, enters the system 200 and outer conduit 202 via input portion 204. As is best shown in FIGS. 31, 32, and 35, the input portion 204 includes an entry opening 210, an exit opening 212, and a tapering portion 214 connecting the entry opening 210 and exit opening 212 (the tapering portion 214 tapering from larger at the entry opening 210 to smaller at the exit opening 212). The input portion 204 is affixable to a confectionary extruder body, which supplies confectionary to the system 200.

As shown in FIGS. 31-33, the input portion 204 is also affixable to the intermediate portion 206 (via threaded engagement, unitary construction, etc.). When the system 200 is assembled as shown in the exemplary embodiment of FIGS. 31-33, the exit opening 212 of the input portion 204 aligns with an entry opening 216 of the intermediate portion 206. This assembly and alignment allows fluid communication between the input portion 204 and intermediate portion 206, wherein confectionary may flow from the input portion 204 to the intermediate portion 206. This flow is assisted by a substantially similar diameter of the exit opening 212 of the input portion 204 and the entry opening 216 of the intermediate portion 206.

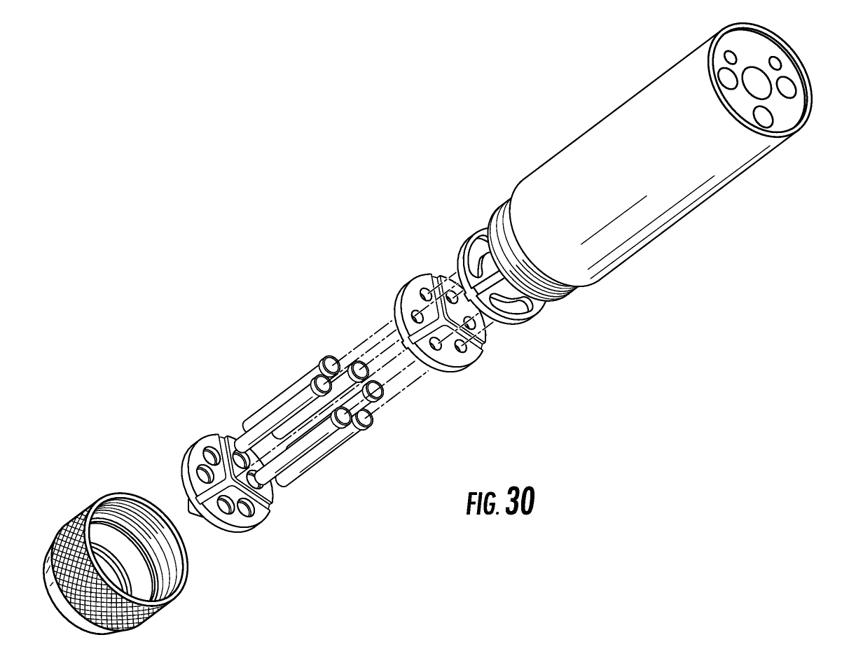

As is best shown in FIGS. 31, 32, and 36, the intermediate portion 206 also includes an association area 218, which is adapted to associate the system 200 with the apparatus 10. The association area 218 includes an association opening 220 and an association recess 222. When the system 200 is fully assembled as shown in the exemplary embodiment of FIGS. 31 and 32 in particular, the entry portion 24 of the apparatus 10 extends into the outer conduit 202 within the intermediate portion 206 via the association opening 220. This extension occurs to a point of abutment between the input block 22 and an outer surface 224 of the association recess 222. In the exemplary embodiment of FIGS. 31 and 32, the input block 22 is affixed to the intermediate portion 206 via threaded engagement, thereby suspending the entry portion 24 and turn portion 26 of the apparatus 10 within the outer conduit 202.

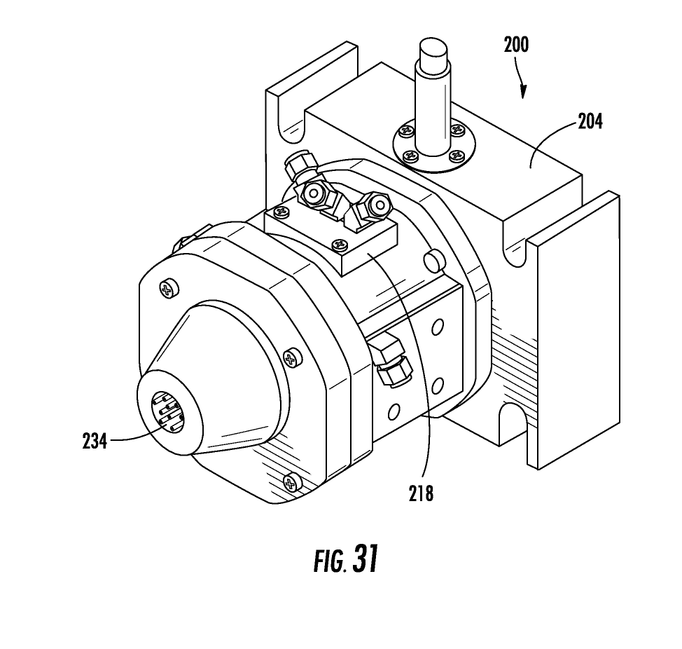

As is shown best via the cross-section of FIG. 33 and phantom lines of FIG. 32, at least a significant portion the apparatus 10 is suspended within the outer conduit 202 such that an end of the turn portion 26 (the end being in proximity to the output section 16), the output section 16, and the nozzle/nozzle support section 18 extend through and beyond an exit opening 226 of the intermediate portion. Suspension of the entry portion 24 and turn portion 26 of the apparatus 10 within the outer conduit 202 in this manner creates a system configuration wherein confectionary flowing through the entry portion 204 and intermediate portion 206 flows around the entry portion 24 and turn portion 26 before entering the output portion 208.

The output portion 208, like the input portion 204, includes an entry opening 228 and a tapering portion 232 connecting the entry opening 228 and exit conduit 230 (the tapering portion 232 tapering from larger at the entry opening 228 to smaller at the start of the exit conduit 230). When the system 200 is assembled as shown in the exemplary embodiment of FIGS. 21-23, the exit opening 226 of the intermediate portion 206 aligns with the entry opening 228 of the output portion 208. This assembly and alignment allows fluid communication between the intermediate portion 206 and output portion 208, wherein confectionary may flow from the intermediate portion 206, around the suspended apparatus portions, and into the output portion 208. This flow is assisted by a substantially similar diameter of the exit opening 226 of the intermediate portion 206 and the entry opening 228 of the output portion 208.

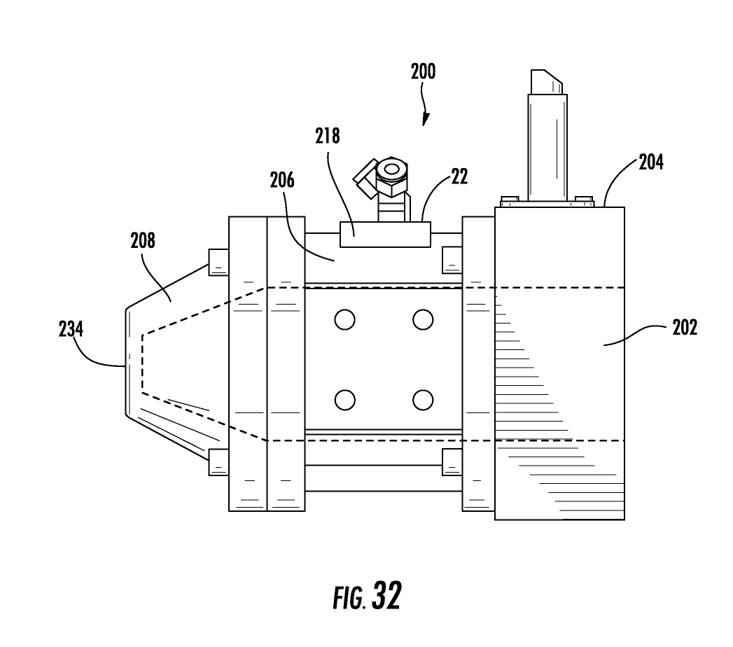

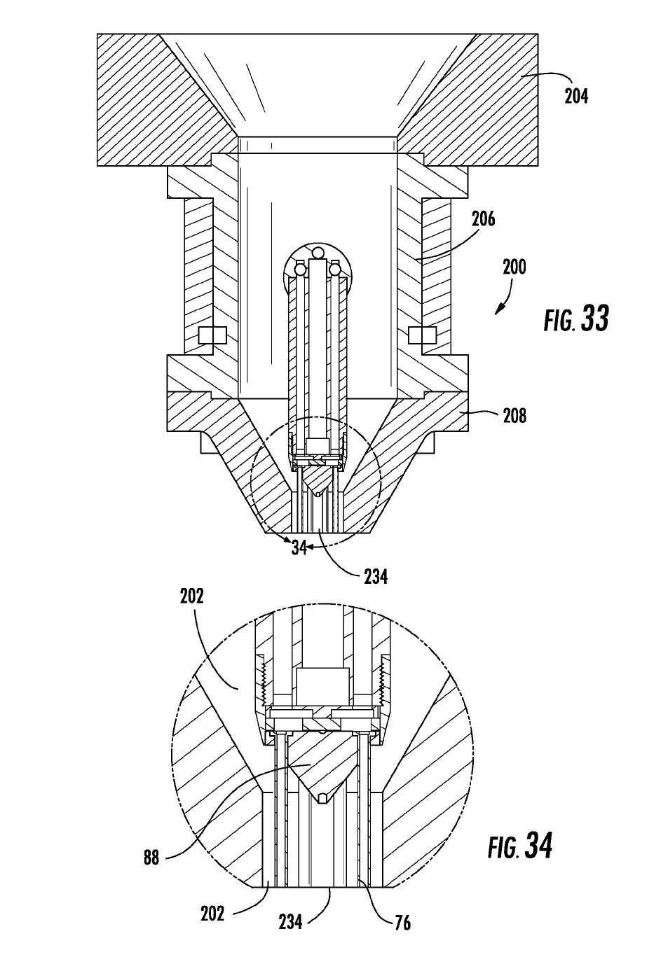

As is mentioned above the end of the turn portion 26, the output section 16, and the nozzle/nozzle support section 18 extend beyond an exit opening 226 of the intermediate portion 206, and therefore into the output portion 208. This extension is best shown in FIGS. 33 and 34. As is best shown in the exemplary embodiment illustrated in the enlarged image of FIG. 34, the nozzle support 88 extends just into the exit conduit 230. The exit conduit 230 (and overall outer conduit 202) terminates at an exit opening 234 of the output portion 208. As shown in FIGS. 31-34, the nozzles 76 of the system 200 and apparatus 10 are suspended within the exit conduit 230 (and held in suspension via the affixing of the block 22 to the intermediate portion 206), and also terminate at (or in close proximity to) the exit opening 234. Via this configuration, confectionary being extruded through the exit conduit 230 passes around the output section 16 and nozzle support 88, as well as around and between the nozzles 76. This extruded confectionary flow (which entered the system 200 via the input portion 204) is then output from the exit opening 234, and thus essentially formed by the output opening 234 into a shape substantially similar in cross-section to a shape of the exit output opening 234.

Concurrently to exit of the confectionary flow from the outer conduit 202 via the exit opening 234, a fluid (such as liquid or gel candy) that enters the apparatus 10 via the ports 20 also exits the nozzles 76, forming fluid filled capillaries within the confectionary output from the system. This fluid forms capillaries with shapes substantially similar in cross-section to a shape of the nozzle output openings. Accordingly, though the nozzles 76 (and openings thereof) shown in the Figures include substantially circular shapes, nozzles with differently shaped openings, such as but not limited to squares, rectangles, triangles, etc., may be desirable.

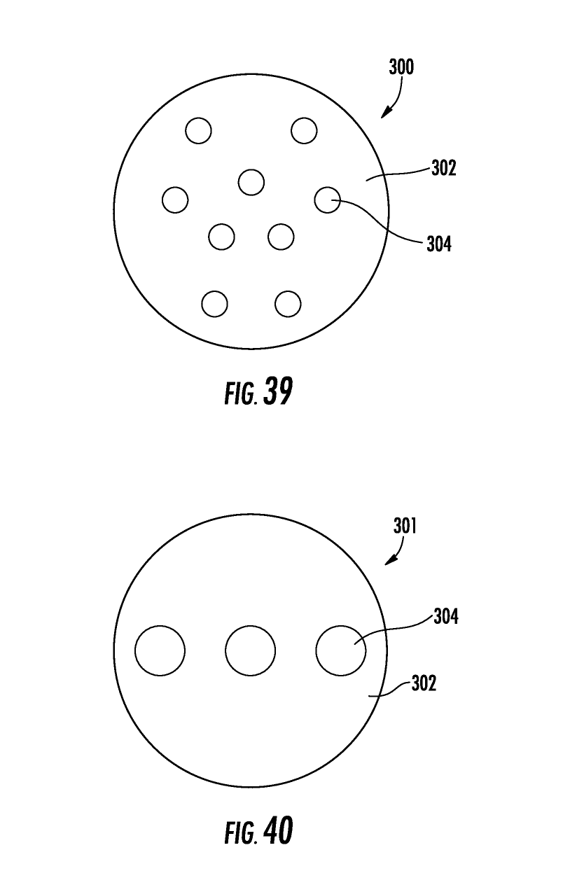

An exemplary embodiment of this confectionary output (as formed by the nine capillary forming nozzle assembly shown in the exemplary embodiment of FIGS. 1-6) is shown via output cross-sections 300 and 301 in FIGS. 39 and 40 respectively. The output cross-sections 300 and 301 both include a body portion 302, surrounding fluid filled capillaries 304. In the exemplary output cross-section 300 of FIG. 39, the body 302 includes nine filled capillaries 304, as formed by the nine capillary forming nozzle assembly shown in the exemplary embodiment of FIGS. 1-6. In the exemplary output cross-section 301 of FIG. 40, the body 302 includes three filled capillaries 304, as formed by the three capillary forming nozzle assembly shown in the exemplary embodiment of FIG. 38.

It should be appreciated that the fluid filled capillaries discussed above may remain unfilled, or partially or completely air-filled. In some other embodiments, one or more of the capillaries may be filled with a material that is different from that of the material used to form the body portion. Some embodiments may include a group of capillaries that are unfilled, or air-filled, and another group of capillaries that are at least partially filled with a fill material. Different capillaries may incorporate different materials if desired. The capillaries may be at least partially filled with a fluid or other material. Such a fluid may comprise a liquid. The capillaries may be filled with a material that is solid at a room temperature and fluid at a temperature greater than room temperature. For example, a molten chocolate may be incorporated into the capillaries and allowed to set when cooled to room temperature. It will be apparent to the skilled addressee that room temperature is commonly regarded as around 20° C. Alternatively, the capillaries may be filled with a material which is deposited as a liquid and which subsequently solidifies. In such embodiments, the solidification may be dependent or independent of heat. It will be apparent that solidification of a liquid filled capillary may be achieved in a number of ways. For example solidification may take place due to one or more of the following:

Cooling—the filling may be molten when deposited which then cools to a solid at room temperature;

Heating—the filling may be liquid when deposited, and the heat of the extruded body portion sets the filling (e.g. pumping egg albumen into a hot hard candy extruded body portion will set the egg on contact);

Drying—the filling may be a solution that dries into a solid (e.g. the moisture from the solution is absorbed into the extruded body portion);

Solvent loss—the filling may be in a solvent, whereby the solvent is absorbed into the extruded body portion, leaving a solid;

Chemical reaction—the filling may be deposited as a liquid but reacts or “goes off” into a solid;

Cross-linking—the filling may form constituents for a cross-linked material due to mixing and/or heating; and

Time—the filling may simply set with time (e.g. a solution of sugars and gelatin will eventually set over time).

Suitable filling materials for the capillaries include, but are not limited to, aqueous media, fats, chocolate, caramel, cocoa butter, fondant, syrups, peanut butter, jam, jelly, gels, truffle, praline, chewy candy, hard candy or any combination or mixture thereof.

The material used to produce the body portion as extruded through the outer conduit may comprise a number of materials commonly use in the production of confectionery—such as but not limited to candy, gum, chocolate, or mixtures thereof.

If desired, the product may further comprise a coating portion to envelop the body portion. The skilled addressee will appreciate that a number of coatings could be employed—for example chocolate, gum, candy and sugar etc.

In fact the product formed and filled by the apparatus 10 and system 200 may include multiple compositions, such as that disclosed in U.S. application Ser. No. 61/316,419, the teachings and disclosures of which being hereby incorporated by reference in their entireties to the extent not inconsistent with the present disclosure

It should be understood that the term “liquid” is intended to mean that the material is capable or has a readiness to flow, including gels, pastes and plasticized chocolate. Furthermore, this term is intended to include (but not limited to) those materials which may be “molten” during extrusion and the skilled addressee will understand that the term “molten” means that the material has been reduced to a liquid form or a form which exhibits the properties of a liquid.

It should be understood that the term “plurality” is intended to mean two or more. In some embodiments, a plurality is 3 or more, or 4 or more, or 5 or more, or 6 or more, or 7 or more. There is no particular upper limit on the number associated with “plurality”. In the context of the phrase “plurality of capillaries”, numbers up to 50 and higher are contemplated.

It should be understood that the term “capillary” generally refers to a conduit or space created by an extrusion or other forming process within the body of the product. The capillary typically contains matter, and that matter can be in the form of a gas, a liquid, a solid, or a mixture thereof.

It should be understood that the term “voidage” generally refers to the volume percent of the capillary volume relative to the sum of the capillary volume and the extruded body portion volume. That is voidage (%)=100×capillary volume/(capillary volume+extruded body portion volume). In some embodiments, the extruded body portion volume does not include any central region volume created by certain dies, such as an annular die.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A nozzle assembly for usage with at least one conduit, the nozzle assembly comprising:
a nozzle support including a nozzle entry surface, a nozzle exit surface, and a plurality of nozzle holding conduits defined by said nozzle support and extending from said nozzle entry surface to said nozzle exit surface, said nozzle support being removably associable with the at least one conduit at said nozzle entry surface; and
a plurality of nozzles that are removably associable with said nozzle support via insertion of said plurality of nozzles into said plurality of nozzle holding conduits, said plurality of nozzles being in fluid communication with the at least one conduit via said removable association between said nozzle support and the at least one conduit.

2. The nozzle assembly as claimed in claim 1, wherein said removable association between said nozzle support and the at least one conduit is achieved via a nozzle base disposed between said nozzle support and the at least one conduit, said nozzle base being removably associated with both of said nozzle support and the at least one conduit.

3. The nozzle assembly as claimed in claim 2, wherein said nozzle base defines a plurality of fluid openings in fluid communication with the at least one conduit, said plurality of fluid openings being alignable with and in equal number to said plurality of nozzle holding conduits.

4. The nozzle assembly as claimed in claim 3, wherein said plurality of nozzles each include an input end with a flange, said flange being disposed between said nozzle entry surface of the nozzle support and said nozzle base.

5. The nozzle assembly as claimed in claim 4, wherein said nozzle entry surface includes a plurality of recesses that are each configured to individually nest with said flanges of said nozzles.

6. The nozzle assembly as claimed in claim 1, wherein said removable association between said nozzle support and the at least one conduit is achieved via a ring with an inner surface that threadingly associates with a body defining the at least one conduit at one area, and abuts said nozzle support at another area, so as to hold said nozzle support in said removable association with the at least one conduit.

7. The nozzle assembly as claimed in claim 1, wherein said nozzle exit surface includes a conical shape, said nozzle holding conduits opening on a slant of said conically shaped nozzle exit surface.

8. The nozzle assembly as claimed in claim 1, wherein said nozzle entry surface includes grooves are ridges configured to nest with grooves or ridges of a body defining the at least on conduit or a body associated with said body defining the at least one conduit.

9. The nozzle assembly as claimed in claim 1, wherein a desirable number of said plurality of nozzle holding conduits and said plurality of nozzles is greater than a number of the at least one conduits.

10. A system for filling a confectionary article, the system comprising:
at least one conduit housed by a conduit housing, said at least one conduit extending from at least one conduit input to a at least one conduit output;
a nozzle support including a nozzle entry surface, a nozzle exit surface, and a plurality of nozzle holding conduits defined by said nozzle support and extending from said nozzle entry surface to said nozzle exit surface, said nozzle support being removably associable with the at least one conduit at said nozzle entry surface; and
a plurality of nozzles that are removably associable with said nozzle support via insertion of said plurality of nozzles into said plurality of nozzle holding conduits, said plurality of nozzles being in fluid communication with the at least one conduit via said removable association between said nozzle support and the at least one conduit.

11. The system as claimed in claim 10, wherein said removable association between said nozzle support and said at least one conduit is achieved via a nozzle base disposed between said nozzle support and said at least one conduit, said nozzle base being removably associated with both of said nozzle support and said at least one conduit.

12. The system as claimed in claim 11, wherein said nozzle base defines a plurality of fluid openings in fluid communication with said at least one conduit, said plurality of fluid openings being alignable with and in equal number to said plurality of nozzle holding conduits.

13. The system as claimed in claim 12, wherein said plurality of nozzles each include an input end with a flange, said flange being disposed between said nozzle entry surface of the nozzle support and said nozzle base.

14. The system as claimed in claim 13, wherein said nozzle entry surface includes a plurality of recesses that are each configured to individually nest with said flanges of said nozzles.

15. The system as claimed in claim 10, wherein said removable association between said nozzle support and said at least one conduit is achieved via a ring with an inner surface that threadingly associates with a body defining said at least one conduit at one area, and abuts said nozzle support at another area, so as to hold said nozzle support in said removable association with said at least one conduit.

16. The system as claimed in claim 10, wherein said nozzle exit surface includes a conical shape, said nozzle holding conduits opening on a slant of said conically shaped nozzle exit surface.

17. The system as claimed in claim 10, wherein said nozzle entry surface includes grooves are ridges configured to nest with grooves or ridges of a body defining said at least on conduit or a body associated with said body defining said at least one conduit.

18. The system as claimed in claim 10, wherein a desirable number of said plurality of nozzle holding conduits and said plurality of nozzles is greater than a number of said at least one conduits.

19. The system as claimed in claim 10, wherein said at least one conduit and said plurality of nozzles are configured for output of a fluid flow, and said housing is an outer conduit configured for extruding a confectionary flow around said at least one conduit and said plurality of nozzles, said plurality of nozzles terminating in proximity to said outer conduit such that the confectionary article is formed by said outer conduit and filled by said plurality of nozzles.
